(19) United States
(12) Patent Application Publication
(10) Pub. No.: US 2006/0182838 A1
(43) Pub. Date: Aug. 17, 2006

(54) Apparatus and method for vacuum forming a film

(76) Inventors: Hyung K. Park, Plymouth Meeting, PA (US); Byung Ho Choi, East Norriton, PA (US); Se Hui Pak, East Norriton, PA (US); Gui Chul Pak, Seoul (KR)

Correspondence Address: LITMAN LAW OFFICES, LTD, PO BOX 15035, CRYSTAL CITY STATION, ARLINGTON, VA, 22215, US

(21) Appl. No.: 11/055,054

(22) Filed: Feb. 11, 2005

(51) Int. Cl. B29C 55/28

(52) U.S. Cl. 425/388

(57) ABSTRACT

The apparatus and method for vacuum forming a film employs a vacuum forming apparatus to form a raw film material into a patterned film material having a concavo-convex pattern. An apparatus for vacuum forming a film comprises a hollow cylindrical roller having an inner surface, an outer surface, and a plurality of vacuum passageways defined therein between the inner and outer surfaces. A mesh layer is disposed around the outer surface of the roller, forming an intermediate layer between the roller and an outer forming layer disposed around the backing layer. The forming layer is a sheet layer of a material having a having a pattern-forming array of apertures defined therethrough. A vacuum applied to an area of the inner surface of the roller draws areas of a heated film material inward against the mesh layer, forming the film material into a concavo-convex pattern.

### BACKGROUND OF THE INVENTION

1. Field of the Invention

The present invention relates to the manufacture of vacuum packing film, and more particularly to an apparatus and method for vacuum forming a film having a concavo-convex surface form.

2. Description of the Related Art

In vacuum packing processes, a first sheet of a vacuum packing film is joined to a backing, often a second sheet of vacuum packing film, by creating a vacuum to remove air from between the first sheet and the backing, thereby sealing the first sheet to the backing. Vacuum packing film is often manufactured with a concavo-convex surface texture, whereby the removal of air from between the vacuum packing film and a backing is facilitated by air passages created by the concavo-convex pattern.

Various methods have been employed for the manufacture of vacuum packing films. Such films are often manufactured from a thermoplastic or polymer material, including nylon and polyester materials. Known methods include laminated coating methods, embossing methods, and resin printing methods. In laminated coating methods, a coating material, such as a thermoplastic or polymer material or resin, is extruded onto a raw film layer, coating the film to form a laminate that is passed through an embossing roller where a pattern is formed in the coating material. The laminate is cooled, resulting in a film laminate having a surface with a concavo-convex surface pattern.

Resin printing methods are similar to the laminated coating methods, except the coating material is extruded onto an embossing wheel prior to being joined to the raw film layer. The patterned surface of the embossing wheel creates a pattern in the coating material before the coating material is applied from the embossing wheel to the raw film layer. In each of the resin printing and the laminated coating methods, an extruder is required to add the thermoplastic or polymer material or resin to the raw film. This results in a somewhat expensive process for producing vacuum packing films. Additionally, these methods produce a vacuum packing film with diminished transparency, because of the added resin and the thickness of the resulting film.

In embossing methods, a raw film is heated and then passed through embossing rollers where a patterned surface of an embossing roller is forcibly pressed against the film so that the film is deformed to create a concavo-convex pattern. Such embossing techniques tend to produce a poor quality of vacuum packing films because the film becomes stretched, and weakened areas are created.

Thus, an apparatus and method for vacuum forming a film solving the aforementioned problems is desired.

### SUMMARY OF THE INVENTION

The apparatus and method for vacuum forming a film employs a vacuum forming apparatus to form a raw film material into a patterned film material having a concavo-convex pattern. An apparatus for vacuum forming a film comprises a forming roller assembly supported on a frame. The forming roller assembly is a hollow cylindrical roller having an inner surface and an outer surface, and having a plurality of vacuum passageways defined therein between the inner and outer surfaces. A thin backing layer of a foraminous material, such as a metal screen or mesh, is disposed around the outer surface of the roller, forming an intermediate layer between the roller and an outer forming layer disposed around the backing layer. The forming layer is a thin sheet layer of a material having a having a pattern-forming array of apertures defined therethrough.

A vacuum manifold is supported by the frame and extends into the hollow interior of the forming roller assembly. A first opening of the vacuum manifold extends lengthwise across the inner surface of the roller, closely in proximity to the inner surface such that a vacuum applied to the vacuum manifold is thereby applied to the forming roller assembly. The vacuum manifold thus defines a vacuum forming region along the forming roller assembly. The vacuum manifold is fixed in position, while the forming roller assembly is rotatable about the vacuum manifold.

The apparatus for vacuum forming a film includes a heating unit disposed proximate to the roller and adjacent to the leading edge of the vacuum forming region, and a cooling unit disposed proximate to the roller and adjacent to the trailing edge of the vacuum forming region.

In a method for vacuum forming a film, a film material is applied to the forming roller assembly rotationally ahead of the heating unit, the film material laying against the forming layer. Rotation of the forming roller assembly passes the film material under the heating unit, where the film material is heated. Continued rotation of the forming roller brings the heated film material over the vacuum forming region, where areas of the heated film material are drawn into the pattern-forming apertures of the forming layer, thereby forming a concavo-convex pattern in the film material. The heated film material is drawn to a depth limited by the backing layer. Continued rotation of the forming roller assembly passes the film material under the cooling unit, where the film material is cooled to fix, or set, the pattern.

These and aspects features of the present invention will become readily apparent upon further review of the following specification and drawings.

### BRIEF DESCRIPTION OF THE DRAWINGS

FIG. 1 is a schematic drawing of a vacuum packing film manufacturing process employing an apparatus and method for vacuum forming a film according to the present invention.

FIG. 2 is a side view of an apparatus for making vacuum packing film according to the present invention, partially cut away to show forming roller details.

FIG. 3 is a front view of a vacuum forming roller according to the present invention, partially cut away to show forming roller details.

FIG. 4 is a section view of a vacuum packing film having a concavo-convex surface form produced by the apparatus and method for vacuum forming a film according to the present invention.

Similar reference characters denote corresponding features consistently throughout the attached drawings.

### DETAILED DESCRIPTION OF THE PREFERRED EMBODIMENT

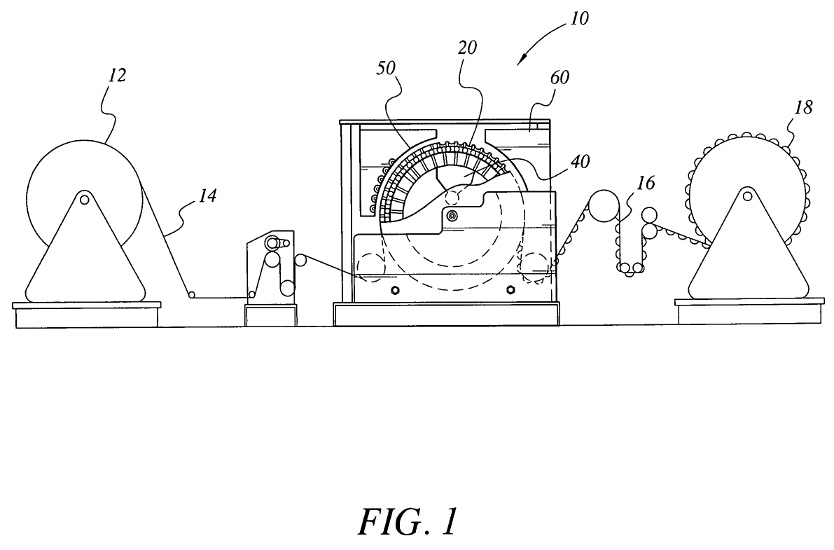

The present invention is an apparatus and method for vacuum forming a film, whereby a film having a concavo-convex pattern useful for vacuum packing and other purposes is made. Turning to FIG. 1, a process is schematically illustrated whereby a concavo-convex pattern is impressed into a raw film material 14 to form a patterned film material 16. A raw film material 14 is fed from a supply roll 12, and passed through an apparatus for vacuum forming a film 10 of the present invention. In the illustrated embodiment, the apparatus for vacuum forming a film 10 comprises a forming roller assembly 20 supported by a frame 11. The forming roller assembly 20 is a hollow cylindrical structure rotatably supported by the frame 11. The raw film material 14 is applied against a surface of the forming roller assembly 20, and travels along a substantial portion of the forming roller assembly 20 surface before exiting the apparatus for vacuum forming a film 10 as a patterned film material 16.

A vacuum manifold 40 is disposed within the forming roller assembly 20 in proximity to an inner surface of the forming roller assembly 20. The vacuum manifold 40 is fixed in position so that the roller assembly 20 may rotate freely past the vacuum manifold 40.

Thus, the raw film material 14 is carried by the rotating roller assembly 20 past the vacuum manifold 40. A heating unit 50 heats the raw film material prior to the passage of the raw film material 14 over the vacuum manifold 40. As the raw film material 14 passes over the vacuum manifold 40, a pattern is formed in the raw film material 14, producing a patterned film material 16, as will be further discussed below. A cooling unit 60 cools the patterned film material 16 to fix the pattern in the patterned film material 16. The patterned film material 16, is collected on a takeup roll 18.

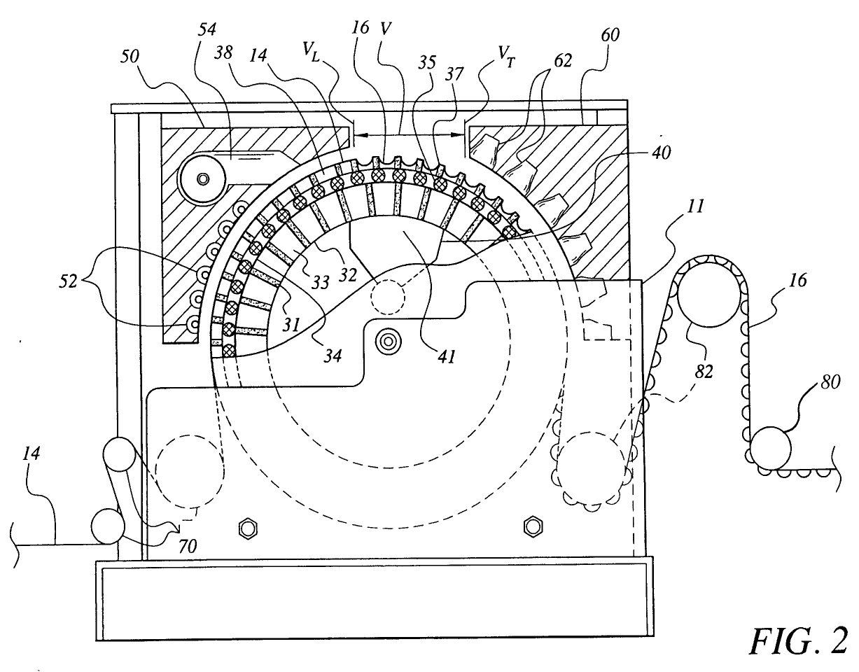

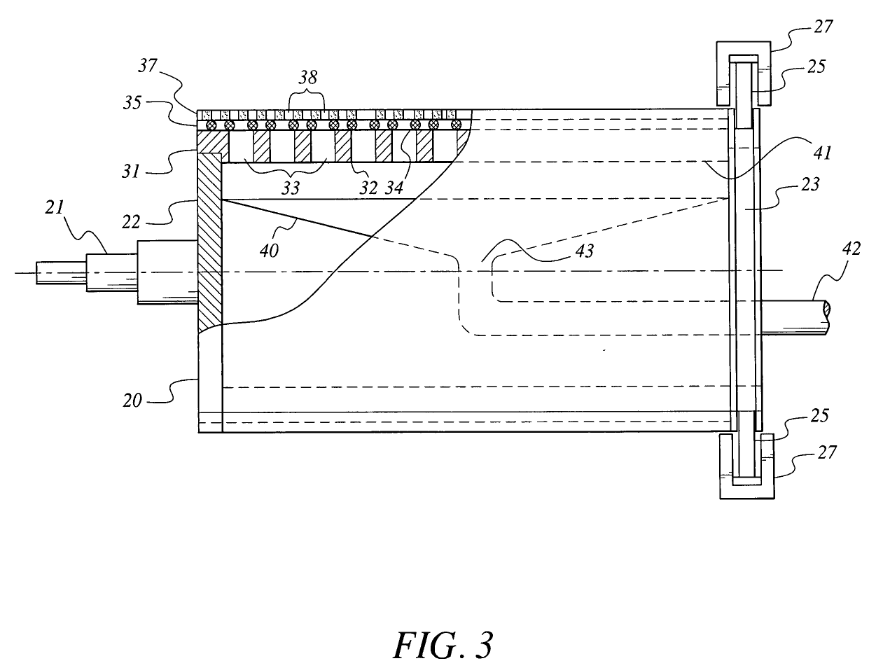

Turning now to FIGS. 2 and 3, the apparatus for vacuum forming a film 10 and the forming roller assembly 20 are discussed in greater detail. The forming roller assembly 20 comprises a hollow cylindrical roller 31, having an inner surface 32 and an outer surface 34. A plurality of vacuum passageways 33 are defined in the roller 31, extending from the inner surface 32 to the outer surface 34. A thin intermediate layer 35 of foraminous material is disposed around the outer surface 34 of the roller 31. A forming layer is disposed around the intermediate layer 37, the forming layer 37 being a thin sheet layer of metal such as aluminum, steel, or the like, having a pattern-forming array of apertures 38 defined therethrough. The size and spacing of the apertures 38 defines a concavo-convex pattern that will be formed in the raw film material 14, while the thickness of the forming layer 37 defines the height or depth of the concavo-convex pattern.

It can be understood that a vacuum applied to the inner surface 32 of the roller 31 will, by way of the vacuum passageways 33 and openings in the foraminous intermediate layer 35, draw areas of raw film material 14 that is applied against the forming layer 37 into the apertures 38, thereby imparting a pattern to the raw film material 14. It can be further understood that the foraminous intermediate layer 35 functions to prevent the raw film material, drawn through the apertures 38, from being drawn to too great a depth. The foraminous intermediate layer 35 and the forming layer 37 thus function together as a means for imparting a pattern to a film material drawn against the forming roller assembly 20 by the vacuum manifold 40.

The foraminous intermediate layer 35, also referred to as a mesh layer or backing layer, is formed of a mesh material, having a mesh opening size that is substantially smaller than the size of the apertures 38, such that a vacuum may be transmitted through the mesh openings while the mesh material provides a suitable backing to prevent the raw film material from being drawn to too great a depth drawn through the apertures 38. Because the foraminous intermediate layer 35 provides a backing to control the concavo-convex pattern depth and uniformity, the vacuum passageways 33 in the roller 31 may be made rather large in relation to the apertures 38 to facilitate vacuum passage.

The vacuum manifold 40 is supported by the frame to extend into the hollow interior of the forming roller assembly 20. A first opening 41 of the vacuum manifold 40 extends lengthwise across the inner surface 32 of the roller 31, the vacuum manifold 40 first opening 41 being positioned closely in proximity to the inner surface 32 such that a vacuum applied to the vacuum manifold 40 is thereby applied to the forming roller assembly 20. The first opening 41 defines a vacuum forming region V on the forming roller assembly 20, the vacuum forming region extending substantially the full length of the forming roller assembly 20 and having a width along the circumference of the forming roller assembly 20. The vacuum forming region V is thus a somewhat elongate rectangular region, having trailing edge V_{T} in the direction of rotation of the forming roller assembly 20, and an opposite leading edge V_{L}.

A second opening 43 of the vacuum manifold is in connection with a vacuum duct 42, that may be further connected to a vacuum source.

A heating unit 50 is supported on the frame 11. The heating unit 50 employs a plurality of heating elements 52, and at least one hot air blower 54, the heating elements 52 and hot air blower 54 positioned proximate to the forming roller assembly and rotationally before the leading edge V_{L} of the vacuum forming region V. The heating unit 50 supplies sufficient heat to a raw film material 14 applied to the forming roller assembly 20 such that the raw film material 14 is softened, the raw film material 14 becoming pliable so that the raw film material 14 readily conforms to the pattern-forming apertures when the vacuum is applied. A cooling unit 60 is supported on the frame 11. The cooling unit employs a plurality of cool air blowers, positioned proximate to the forming roller assembly 20 and rotationally following the trailing edge V_{T} of the vacuum forming region V.

The forming roller assembly 20 is supported on the frame 11 by a shaft 21, axially extending from an end wall 22 that encloses a first end of the forming roller assembly 20, the shaft 22 being journalled by the frame 11 or by a bearing supported by the frame 11. The second end of the forming roller assembly 20 is left open, to accommodate the placement of the vacuum manifold within the forming roller assembly 20, and is supported by the frame 11 by a plurality of roller bearings 25, retained to the frame 11 by bearing holders 27. The roller bearings 25 engage with a roller bearing guide 23, the roller bearing guide being a guide track disposed circumferentially about the second end of the forming roller assembly 20.

Tensioning and guide rollers are positioned to handle, and to help transport, the film material entering and exiting the apparatus for vacuum forming a film 10. A plurality of infeeding tensioning and guide rollers 70 are positioned to handle and help transport the raw film material 14 entering the apparatus for vacuum forming a film 10, aiding in the application of the raw film material 14 to the forming roller assembly 20 ahead of the heating unit 50 and the vacuum forming region V. The tensioning and guide rollers 70 function in a conventional manner to maintain even and correct tensioning of the raw film material 14, and to guide the raw film material into contact with the forming roller assembly 20.

Outfeeding rollers handle the patterned film material 16 exiting the apparatus for vacuum forming a film 10, and include outfeeding tensioning and guide rollers 80, and outfeeding cooling rollers 82. The outfeeding tensioning and guide rollers 80 function in a conventional manner, along with cooling rollers 82, to maintain even and correct tensioning of the patterned film material 16, and to guide the patterned film material 16 away from the forming roller assembly 20. Additionally, the cooling rollers 82 provide additional cooling to the patterned film material 16 to further set the concavo-convex pattern.

A film having a concavo-convex pattern is formed by bringing a raw film material 14 into contact with the forming roller assembly 20. The raw film material 14 is brought into contact with the forming roller assembly 20 by infeeding tensioning and guide rollers 70, rotationally ahead of the heating unit 50. As the forming roller assembly rotates, the film is carried along, remaining in contact with the forming roller assembly 20, to a point rotationally past the cooling unit 60.

The raw film material 14 passes below the heating unit 50, where it is heated by the heating unit 50 prior to passing over the vacuum forming region V. The raw film material is heated so that the raw film material becomes somewhat deformable. The heated raw film material 14 is passed over the vacuum forming region V, where a vacuum applied to the vacuum manifold 40 draws the heated raw film material 14 into the pattern-forming apertures 38 of the forming layer 37. As the heated raw film material 14 is drawn into the apertures 38, the depth is limited by the foraminous intermediate layer 35, thereby controlling the uniformity of the pattern depth. Drawing the heated raw film material 14 into the pattern-forming apertures 38 of the forming layer 37 causes the heated raw film material 14 to become deformed and transformed into a patterned film material 16, the patterned film material 16 taking on the concavo-convex pattern of the pattern-forming apertures 38 of the forming layer 37.

As the patterned film material 16 continues past the vacuum forming region V, the patterned film material 16 is passed below the cooling unit 60, where it is cooled by the cooling unit 60 to fix or set the pattern vacuum formed by the pattern-forming apertures 38 of the forming layer 37.

Following the cooling unit 60, the patterned film material 16 is guided away from the forming roller assembly 20 by cooling rollers 82, which further cool the patterned film material 16, and by outfeeding tensioning and guide rollers 80.

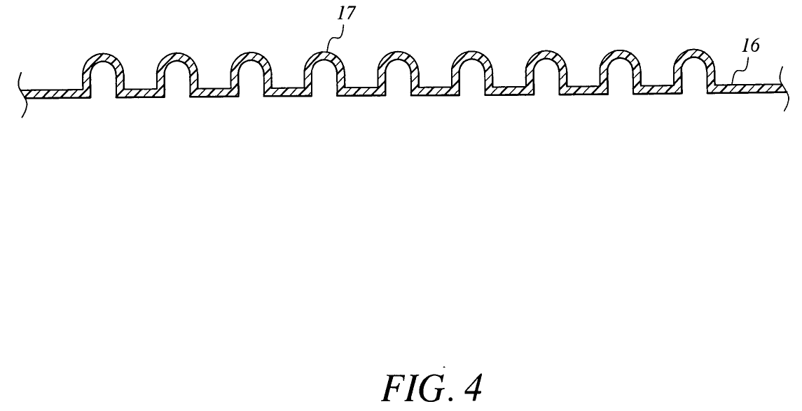

Turning now to FIG. 4, a section view of the patterned film material 16 shows the concave-convex pattern 17 formed. It can be recognized that a variety of materials are suitable for use with the apparatus and method for vacuum forming a film of the present invention, such as thermoplastic or polymer materials including nylon and polyester materials.

Because the pattern depth is limited during formation by the foraminous intermediate layer 35, the patterned film material 16 exhibits a uniformity in both pattern and film thickness. The uniformity in pattern and film thickness leads to a patterned film material 16 that may be thinner than conventionally produced films, while exhibiting improved strength since the uniform pattern and film thickness eliminates weak areas found in materials produced by other processes wherein pattern formation may result in portions of a film material being drawn excessively thin.

Moreover, the improved uniformity in pattern and film thickness resulting from the method for vacuum forming a film described herein yields a more transparent patterned film material 16 since the patterned film material 16 does not incorporate a resin layer, and because the improved uniformity in pattern and film thickness eliminates surface and thickness variations that degrade transparency.

It is to be understood that the present invention is not limited to the embodiment described above, but encompasses any and all embodiments within the scope of the following claims.

We claim:

1. An apparatus for vacuum forming a film, comprising:
a frame;
a hollow cylindrical roller rotatably supported on said frame, the roller having an inner surface and an outer surface;
a plurality of vacuum passageways defined through said roller;
a thin intermediate layer of foraminous material disposed around the outer surface of said roller;
an outer forming layer disposed around the intermediate layer, the forming layer having a pattern-forming array of apertures defined therethrough;
a vacuum manifold having a first opening and a second opening, the first opening disposed proximate to and extending lengthwise along the inner surface of said roller, the first opening defining a vacuum forming region having a leading edge and a trailing edge; and
a vacuum duct in communication with said second opening;
wherein said roller is rotatable about said vacuum manifold and has a forward rotating direction.

2. The apparatus for vacuum forming a film according to claim 1, wherein said intermediate layer is a wire mesh material.

3. The apparatus for vacuum forming a film according to claim 2, wherein said wire mesh has a mesh opening size that is substantially smaller than the apertures defined in said outer forming layer.

4. The apparatus for vacuum forming a film according to claim 2, wherein said vacuum passageways are larger than the apertures defined in said outer forming layer.

5. The apparatus for vacuum forming a film according to claim 1, further comprising a heating unit disposed proximate to said roller and adjacent to the leading edge of said vacuum forming region.

6. The apparatus for vacuum forming a film according to claim 5, wherein said heating unit comprises a plurality of heating elements.

7. The apparatus for vacuum forming a film according to claim 5, wherein said heating unit comprises at least one hot air blower.

8. The apparatus for vacuum forming a film according to claim 1, further comprising a cooling unit disposed proximate to said roller and adjacent to the trailing edge of said vacuum forming region.

9. The apparatus for vacuum forming a film according to claim 8, wherein said cooling unit comprises at least one cool air blower.

10. An apparatus for vacuum forming a film, comprising:
a frame;
a hollow cylindrical roller rotatably supported on said frame, the roller having an inner surface and an outer surface;
a plurality of vacuum passageways defined through said roller;
a vacuum manifold having a first opening and a second opening, the first opening disposed proximate to and extending lengthwise along the inner surface of said roller, the first opening defining a vacuum forming region having a leading edge and a trailing edge; and
a vacuum duct in communication with said second opening;
a vacuum source in communication with said vacuum duct; and
patterning means for imparting a concavo-convex pattern to a film material drawn by said vacuum source toward said roller.

11. The apparatus for vacuum forming a film according to claim 10, wherein said patterning means comprises:
a backing layer of foraminous material disposed around the outer surface of said roller; and
a forming layer disposed around backing layer, the forming having a pattern-forming array of apertures defined therethrough.

12. The apparatus for vacuum forming a film according to claim 11, wherein said backing layer is a wire mesh material.

13. The apparatus for vacuum forming a film according to claim 12, wherein said wire mesh has a mesh opening size that is substantially smaller than the apertures defined in said forming layer.

14. The apparatus for vacuum forming a film according to claim 10, further comprising a heating unit disposed proximate to said roller and adjacent to the leading edge of said vacuum forming region.

15. The apparatus for vacuum forming a film according to claim 14, wherein said heating unit comprises a plurality of heating elements.

16. The apparatus for vacuum forming a film according to claim 15, wherein said heating unit comprises at least one hot air blower.

17. The apparatus for vacuum forming a film according to claim 10, further comprising a cooling unit disposed proximate to said roller and adjacent to the trailing edge of said vacuum forming region.

18. A method for vacuum forming a film, comprising the steps of:
applying a film material to a forming roller having an outer forming layer having a pattern-forming array of apertures defined therein, an intermediate wire mesh layer, and in inner supporting layer having a plurality of vacuum passageways defined therethrough;
heating said film material;
applying a vacuum source to an interior surface region of said forming roller, whereby areas of said heated film material are drawn into said pattern-forming apertures to a depth limited by said intermediate wire mesh layer; and
cooling said film material.

19. A patterned film material having a concavo-convex pattern produced according to the method of claim 18.
